(19) United States
(12) Patent Application Publication
(10) Pub. No.: US 2024/0262949 A1
(43) Pub. Date: Aug. 8, 2024

(54) TWO-WAY SHAPE MEMORY POLYURETHANE AND PREPARATION METHOD THEREOF

(71) Applicants: SHANGHAI JIAO TONG UNIVERSITY, Shanghai (CN); Dr Industrial Robotic Technology Ltd, Shanghai (CN)

(72) Inventors: Yujie CHEN, Shanghai (CN); Yutong GUO, Shanghai (CN); Xiaopeng SHEN, Shanghai (CN); Dandan YU, Shanghai (CN); Jing YU, Shanghai (CN); Hezhou LIU, Shanghai (CN)

(73) Assignees: SHANGHAI JIAO TONG UNIVERSITY, Shanghai (CN); Dr Industrial Robotic Technology Ltd, Shanghai (CN)

(21) Appl. No.: 18/519,355

(22) Filed: Nov. 27, 2023

(30) Foreign Application Priority Data
Feb. 3, 2023 (CN) 202310092965.7

(51) Int. Cl. C08G 18/12; C08G 18/24; C08G 18/42; C08G 18/48; C08G 18/69; C08K 5/17

(52) U.S. Cl. CPC C08G 18/12; C08G 18/246; C08G 18/4277; C08G 18/4833; C08G 18/69; C08K 5/17; C08G 2280/00

(57) ABSTRACT

Disclosed are a two-way shape memory polyurethane and a preparation method thereof. The two-way shape memory polyurethane includes the following components: in parts by weight, 4 parts to 36 parts of hydroxyl-terminated polybutadiene, 35 parts to 85 parts of hydroxyl-terminated polycaprolactone, 7 parts to 21 parts of a diisocyanate, 15 parts to 45 parts of polyethylene glycol, and 4 parts to 10 parts of a cross-linking agent.

### CROSS REFERENCE TO RELATED APPLICATION

This patent application claims the benefit and priority of Chinese Patent Application No. 202310092965.7 filed with the China National Intellectual Property Administration on Feb. 3, 2023, the disclosure of which is incorporated by reference herein in its entirety as part of the present application.

### TECHNICAL FIELD

The present disclosure belongs to the technical field of the synthesis of functional polymer materials, and in particular relates to a polyurethane material with excellent mechanical properties and a shape memory effect, and a preparation method thereof.

### BACKGROUND

Shape memory polymer is a smart polymer material that can return to its original shape from a temporary shape after being stimulated by external environmental stimuli such as light, heat, electric fields, chemical environments, and magnetic fields. The process of fixation at temporary shape and then restoration to original shape is known as a shape memory effect. A mechanism of shape memory polymers is based on the inclusion of a stationary phase and a reversible phase that enables shape fixation and recovery. In addition, shape memory polymers have various advantages, including light weight, high stress resistance, easy processing, large recoverable deformation, adjustable elastic modulus, rich stimulus response, and programmable properties. Moreover, this type of polymer shows broad application prospects in the fields such as self-tightening sutures, packaging materials, textile coatings, aerospace, and self-healing materials, as well as multi-response sensors, soft robots, actuators, and medical care. Among them, the soft robot is a current research hotspot. Traditional rigid robots have complex structures and poor flexibility, are difficult to pass through spaces with specific structures and cannot adapt to complex-shaped passages. Therefore, these robots cannot meet the needs of complex engineering and human-computer interaction. Compared with the traditional rigid robots, soft robots are receiving increasing attention in medical care, education, services, rescue, exploration, detection, wearable devices and other fields due to their inherent great flexibility, desirable compliance, excellent adaptability, and natural and safe interactivity. Moreover, this type of robot shows a great potential for development and can play an important role in delicate tasks that traditional rigid robots is unable to complete. The flexibility of soft robots provides a new way to solve the problems faced with traditional equipment such as robots, actuators, and grippers. The soft robots could complete relatively complex movements by virtue of its highly nonlinear response to driving, thereby achieving tasks that are difficult to complete with traditional rigid devices.

Polyurethane is a block polymer with soft and hard segments whose properties can be programmed through molecular designs. A typical thermoresponsive shape memory polymer could be prepared by designing polyurethane networks with two different melting temperatures. However, it is difficult for the shape memory polymers to simultaneously possess performance characteristics such as high response speed, excellent mechanical properties, high energy and power densities, and perfect shape memory performance, some of which may require opposite polymer structures. For example, high energy density and power density require high crystallinity, but meanwhile result in higher Young's modulus, lower elongation at break, and higher brittleness.

CN107163211A discloses a preparation method of a shape memory polyurethane containing adamantane star-shaped polycaprolactone. In this method, tetrahydroxyadamantane star-shaped polycaprolactone, diisocyanate, and a small-molecule linking agent are used to prepare a polyurethane material with a stable cross-linked structure. Adamantane is cage-like rigid body with circumferential symmetry and a highly stable rigid structure, and could improve the thermal stability and mechanical properties of polymer materials. However, raw materials of this type of polymer are relatively expensive and difficult to obtain, thus limiting practical application prospects. CN109912773A discloses a preparation method of a shape memory polyurethane synthesized from polycaprolactone, polyethylene glycol, diisocyanate, and spiral non-planar and planar chain extenders. This polymer material has an elongation at break of 500% to 600%, a tensile strength of 15 MPa to 20 MPa, and a thermal decomposition temperature of 280° C. to 320° C. However, the preparation method is relatively cumbersome and requires microwave reaction and other processes, and the resulting product could only exhibit a one-way shape memory behavior.

CN202210280000.6 discloses a polymer film material with a high dielectric constant and a preparation method thereof. The polymer film material includes the following components: in parts by weight, 30 parts to 62.5 parts of hydroxyl-terminated polybutadiene, 15 parts to 32 parts of hydroxyl-terminated polycaprolactone, 8 parts to 21 parts of diisocyanate, 11 parts to 25 parts of polyethylene glycol, and 0.5 parts to 3 parts of azobenzene. The introduction of the polycaprolactone and polybutadiene improves mechanical properties of the polymer film material; while the polyethylene glycol and azobenzene increase a molecular polarity of the polymer film material, thereby significantly increasing the dielectric constant. Accordingly, a resulting polymer film could achieve both desirable mechanical properties and a high dielectric constant. This technology improves the mechanical properties of the polymer film material. However, since a main purpose is to increase the dielectric constant of the material, special azobenzene molecules are compounded with materials such as the polybutadiene. As a result, the polymer film material has a higher dielectric constant as well as a higher Young's modulus. However, the polymer film material is not cross-linked and thus does not have two-way shape memory properties.

### SUMMARY

An object of the present disclosure is to solve the above technical problems and provide a two-way shape memory polyurethane material with excellent mechanical properties and a preparation method thereof.

The object of the present disclosure can be achieved through the following technical solutions: a two-way shape memory polyurethane, including the following components: in parts by weight, 4 parts to 36 parts of hydroxyl-terminated polybutadiene, 35 parts to 85 parts of hydroxyl-terminated polycaprolactone, 7 parts to 21 parts of a diisocyanate, 15 parts to 45 parts of polyethylene glycol, and 4 parts to 10 parts of a cross-linking agent.

In some embodiments, the hydroxyl-terminated polybutadiene has a weight-average molecular weight of 2,700 to 4,600.

In some embodiments, the hydroxyl-terminated polycaprolactone has a weight-average molecular weight of 3,000 to 50,000, and the polyethylene glycol has a weight-average molecular weight of 1,000 to 20,000.

In some embodiments, the diisocyanate is at least one selected from the group consisting of isophorone and diisocyanate, hexamethylene diisocyanate, dicyclohexylmethane 4,4′-diisocyanate.

In some embodiments, the cross-linking agent is at least one selected from the group consisting of N,N,N′,N′-tetrakis(2-hydroxypropyl)ethylenediamine (HPED) and triethanolamine (TEA).

The present disclosure further provides a method for preparing the two-way shape memory polyurethane, including the following steps:
(1) dissolving the hydroxyl-terminated polybutadiene, the diisocyanate, and the hydroxyl-terminated polycaprolactone in a solvent, adding dibutyltin dilaurate dropwise as a catalyst, and conducting reaction at a temperature of 70° C. to 90° C. under nitrogen protection for 1 h to 3 h to obtain a prepolymer;
(2) adding the polyethylene glycol and the cross-linking agent into the prepolymer, and conducting reaction at a temperature of 65° C. to 75° C. under nitrogen protection for 0.5 h to 1 h to obtain a polyurethane solution; and
(4) deaerating the polyurethane solution under vacuum to obtain a deaerated polyurethane solution, transferring the deaerated polyurethane solution to a mold, and conducting polymerization at a temperature of 80° ° C. to 120° C. while removing the solvent for 6 h to 8 h, to obtain the two-way shape memory polyurethane with excellent mechanical properties and a shape memory effect.

In some embodiments, a ratio of a mass of the catalyst to a total mass of the hydroxyl-terminated polybutadiene and the hydroxyl-terminated polycaprolactone is in a range of 1:10 to 1:25.

In some embodiments, the solvent is at least one selected from the group consisting of N,N-dimethylformamide (DMF), ethyl acetate, and cyclohexane.

In some embodiments, the two-way shape memory polyurethane has an elongation at break of 500% to 2,500% and a tensile strength of 5 MPa to 30 MPa.

In some embodiments, the two-way shape memory polyurethane has a strain fixity rate R_{f} of 60% to 99%, a strain recovery rate Rr of 95% to 99%, an energy density W of 200 J/kg to 710 J/kg, and a power density P of 130 W/kg to 670 W/kg.

In some embodiments, the two-way shape memory polyurethane exhibits a reversible strain of 5% to 25% under an external stress, and a reversible strain of 5% to 15% under stress-free condition.

In some embodiments, the method further includes in step (3), adjusting a shape and a size of the mold and an amount of the polyurethane solution to be cast to obtain polyurethane films with different forms.

In the present disclosure, the mechanical properties and shape memory effect of the polymer material can be controlled by changing the contents of different components. The material can have an elongation at break of 500% to 2,500%, a tensile strength ranging from 5 MPa to 30 MPa, and a shape memory effect of greater than 95%. Meanwhile, the polyurethane could achieve a reversible strain of 5% to 25% under an external stress and a reversible strain of 5% to 15% under stress-free condition.

Compared with the prior art, some embodiments of the present disclosure have the following advantages:
1. In the present disclosure, the overall configuration of a molecular chain in the polyurethane polymer material is ensured through cross-linking. During the first deformation programming, as the temperature increases accompanied with stretching by external stress, the folded segments of the polymer are stretched; however, the existence of cross-linking points allows the polymer network configuration to be maintained, and therefore the polymer is fixed to a temporary shape after cooling. During the second heating, the stretched polymer chains return to their original state driven by entropy, and the polymer material returns to its original shape. If the temperature is lowered again, the polyurethane may undergo cooling-induced crystallization, driving the polyurethane material to elongate under the action of an external stress or internal stress. This process of reversible deformation for a polymer material under different temperature conditions is called a two-way shape memory behavior. In this polyurethane system, polycaprolactone and polyethylene glycol segments are crystalline polymer segments that could keep the polyurethane in a temporary shape, and could store and release energy to drive shape memory behavior during the shape memory process. The polybutadiene segments are amorphous chain segments at room temperature, and could regulate the crystallinity of polyurethane, thereby regulating mechanical properties of the material. In addition, the polybutadiene segments could store and release stress and induce the polyurethane to achieve two-way shape memory behavior without the action of external stress.
2. In the polyurethane polymer material according to the present disclosure, mechanical properties and shape memory properties could be regulated by regulating the proportion of components.
3. In the shape memory polyurethane according to the present disclosure, the crystallinity and hydrogen bond density of the polymer could be regulated by regulating the ratio of polycaprolactone and polyethylene glycol, thereby regulating the mechanical properties of the polyurethane. In addition, microphase separation and crystallinity of the polymer could be further changed by controlling the proportion of amorphous polybutadiene molecular chain, thereby improving mechanical properties. The polyurethane has an elongation at break of 500% to 2,500%, a tensile strength of 5 MPa to 30 MPa, a true tensile strength as large as 590 MPa. The polyurethane also shows a strain recovery rate of not less than 95%, a power density of 200 J/kg to 710 J/kg, and an energy density of 130 W/kg to 670 W/kg.
4. In the present disclosure, non-oriented molecular chains of the polyurethane polymer material could store and release stress during the stretching and shape recovery respectively, thereby enhancing the two-way shape memory effect, or inducing the occurrence of two-way shape memory behavior without external stress. The polyurethane polymer material could achieve a reversible strain of 5% to 25% under an external stress and a reversible strain of 5% to 15% under stress-free condition.
5. In the preparation method according to the present disclosure, products with different shapes could be prepared by changing the mold.

### BRIEF DESCRIPTION OF THE DRAWINGS

FIG. 1 shows a schematic diagram of the principle of a two-way shape memory behavior in Example 1.

FIG. 2 shows an infrared spectrum of the polyurethane obtained in Example 1 of the present disclosure.

FIG. 3 shows a stress-strain curve of the polyurethane obtained in Example 1.

FIG. 4 shows a dynamic mechanical analysis (DMA) curve of the polyurethane obtained in Example 1.

FIG. 5 shows a stress-strain curve of the polyurethane obtained in Example 2.

FIG. 6 shows a DMA curve of the polyurethane obtained in Example 2.

FIG. 7 shows a DMA curve of the polyurethane obtained in Example 2 under stress-free condition.

FIG. 8 shows a stress-strain curve of the polyurethane obtained in Example 3.

FIG. 9 shows a DMA curve of the polyurethane obtained in Example 3.

FIG. 10 shows a stress-strain curve of the polyurethane obtained in Example 4.

FIG. 11 shows a DMA curve of the polyurethane obtained in Example 4.

FIG. 12 shows a stress-strain curve of the polyurethane obtained in Example 5.

FIG. 13 shows a DMA curve of the polyurethane obtained in Example 5.

FIG. 14 shows a stress-strain curve of the polyurethane obtained in Comparative Example 1.

### DETAILED DESCRIPTION OF THE EMBODIMENTS

The present disclosure will be described in detail below with reference to the drawings and specific examples.

The present disclosure provides a method for preparing a two-way shape memory polyurethane, which includes components: hydroxyl-terminated polybutadiene, hydroxyl-terminated polycaprolactone, polyethylene glycol, a cross-linking agent, and a diisocyanate. Raw materials used are commercially available.

### Example 1

A two-way shape memory polyurethane was prepared according to the following procedures:

At room temperature, 0.05 g of hydroxyl-terminated polybutadiene with a weight-average molecular weight of 2,700, 0.7 g of hydroxyl-terminated polycaprolactone with a weight-average molecular weight of 20,000, and 0.09 g of hexamethylene diisocyanate were dissolved in 10 mL of ethyl acetate at 65° C. and mixed evenly by stirring. A resulting mixture was heated to 80° C., and 50 mg of dibutyltin dilaurate was added dropwise thereto as a catalyst. A reaction was conducted under nitrogen protection at a rotation speed of 600 r/min for 1 h, obtaining a first prepolymer.

0.3 g of polyethylene glycol with a weight-average molecular weight of 6,000 and 0.08 g of HPED were dissolved in 3 mL of ethyl acetate at 60° ° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles, and then evenly transferred to a square polytetrafluoroethylene mold. The mold was transferred to an oven at 80° C. and dried for 8 h to remove the solvent.

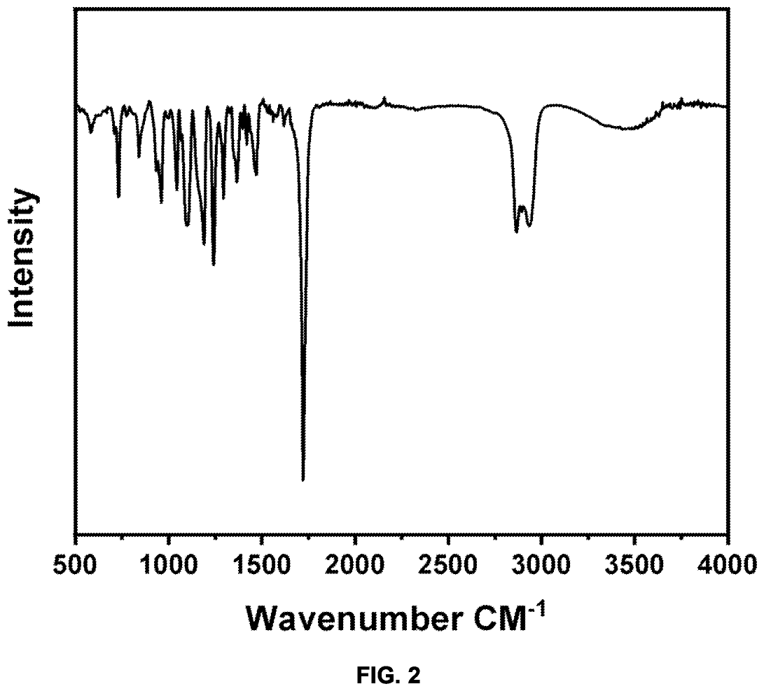

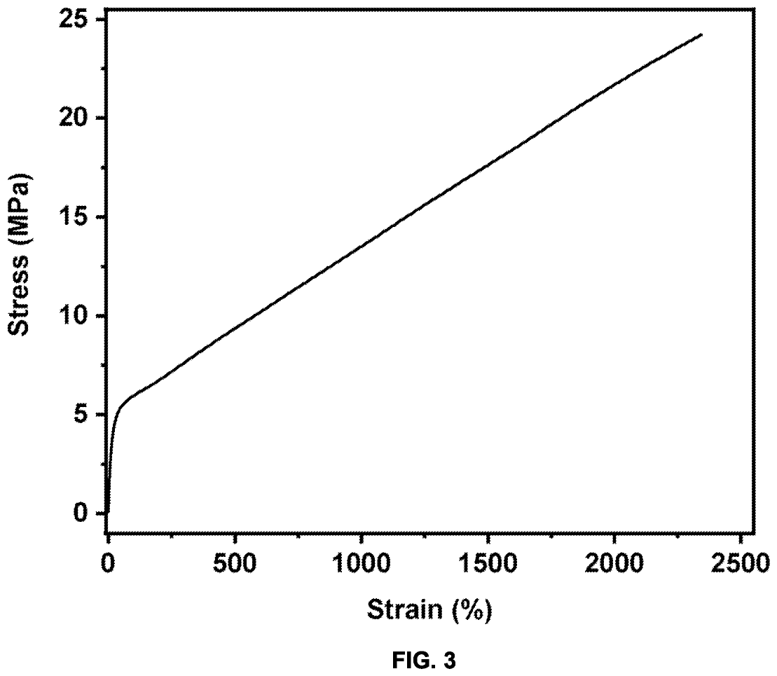

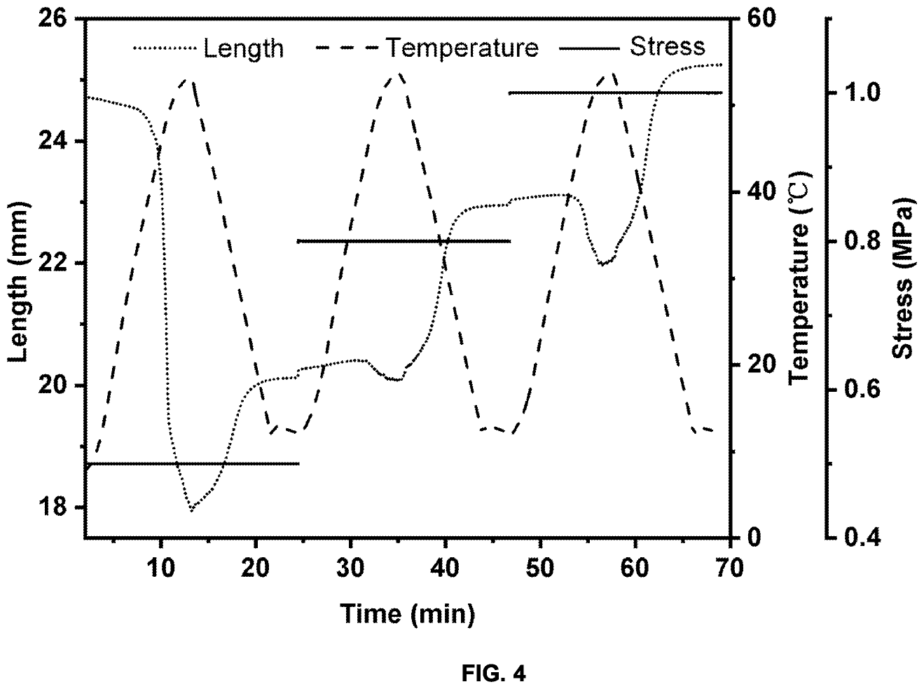

A resulting polyurethane film was demolded. An infrared absorption spectrum of the film was tested with a Fourier transform infrared spectrometer, mechanical properties of the film were tested with a universal electronic tensile tester, and shape memory performance of the film was tested with a dynamic mechanical analyzer. The results of tests are shown in FIG. 2, FIG. 3, and FIG. 4, respectively.

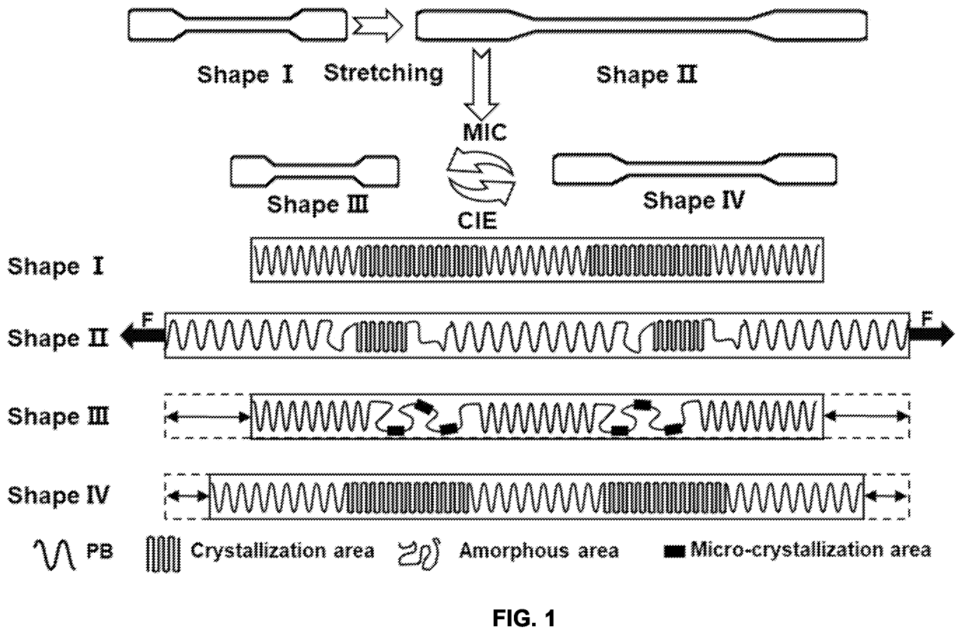

FIG. 1 shows a schematic diagram of a two-way shape memory mechanism of the polyurethane material, illustrating the states of different types of polymer segments in the polyurethane network during shape programming and deformation under different conditions. In an initial state (Shape I), crystalline segments and amorphous segments are alternated. The shape of the polyurethane material is programmed by heating and stretching, and then cooling while maintaining external stress to fix the polymer into a temporary shape (Shape II). It can be seen that in this form, the polymer chain segments are stretched, and meanwhile, there are tiny crystal regions oriented along a stretching direction. After that, the temperature is raised again to above a critical temperature. As polybutadiene could act like a “molecular spring”, the polymer has an internal stress along the stretching direction, or a certain external stress is maintained, the shape of the polyurethane material could be restored to a state (Shape III) similar to the original shape. In this form, the molecular chains of polyurethane tend to be isotropic under the driving of entropy, and the stretched molecular chains retract; further, the existence of cross-linking points keeps the overall configuration of the polymer network unchanged, thereby restoring macroscopically the shape of the polyurethane material. However, because the temperature is still above the critical point, only tiny crystalline regions exist. After that, the temperature drops again. Due to the existence of internal stress or external stress, the polymer chain segments are induced to orient and crystallize along the stress direction, showing a cooling-induced crystallization elongation effect on a macroscopic level. As a result, the polymer material takes on a new shape (Shape IV). If the material is heated and cooled again, the polyurethane could be cycled between the Shape III and Shape IV, which is called a two-way shape memory behavior.

As can be seen from the infrared spectrum in FIG. 2, there are vibration absorption peaks of the CH═CH bond at 912 cm⁻¹ and 995 cm⁻¹, proving that polybutene has been introduced. In addition, peaks at 1,106 cm⁻¹ and 1,145 cm⁻¹ are attributed to the vibration absorption of the ether bond O═C—O—C═O, and the peak at 1,725 cm⁻¹ is attributed to the vibration adsorption of the ester bond, proving that urethane bond has been formed. In addition, peaks at 1,241 cm⁻¹ and 1,045 cm⁻¹ are attributed to ═C—O—C stretching vibration, the peaks at (2,946-2,855) cm⁻¹ are attributed to the stretching vibration of methylene, and the peak at 1,635 cm⁻¹ is attributed to the stretching vibration peak of C═C bond. In the infrared spectrum, there is no characteristic peak of the stretching vibration of the hydroxyl group (at 3,400-3,500 cm⁻¹) and characteristic peak of the stretching vibration of the isocyanate group (at 2,260 cm⁻¹), which also proves that the diisocyanate has been reacted with the terminal hydroxyl groups into a urethane bond.

FIG. 3 shows a tensile stress-strain curve of the polyurethane material in this example. As can be seen from FIG. 3, the material has a tensile strength of 24 MPa and an elongation at break of 2,343%.

FIG. 4 shows a shape memory behavior of the polyurethane material in this example under different stresses. As can be seen from FIG. 4, a two-way reversible strain is 13.52% at 0.5 MPa, 14.92% at 0.8 MPa, and 14.7% at 1 MPa.

### Example 2

A two-way shape memory polyurethane was prepared according to the following procedures:

At room temperature, 0.1 g of hydroxyl-terminated polybutadiene with a weight-average molecular weight of 3,200, 0.7 g of hydroxyl-terminated polycaprolactone with a weight-average molecular weight of 20,000, and 0.1 g of hexamethylene diisocyanate were dissolved in 10 mL of DMF at 60° C. and mixed evenly by stirring. A resulting mixture was heated to 80° C., and 50 mg of dibutyltin dilaurate was added dropwise thereto as a catalyst. A reaction was conducted under nitrogen protection at a rotation speed of 600 r/min for 1 h, obtaining a first prepolymer.

0.3 g of polyethylene glycol with a weight-average molecular weight of 6,000 and 0.08 g of HPED were dissolved in 1 mL of DMF at 60° ° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles therein, and then evenly transferred to a square polytetrafluoroethylene mold. The mold was transferred to an oven at 80° C. and dried for 8 h to remove the solvent.

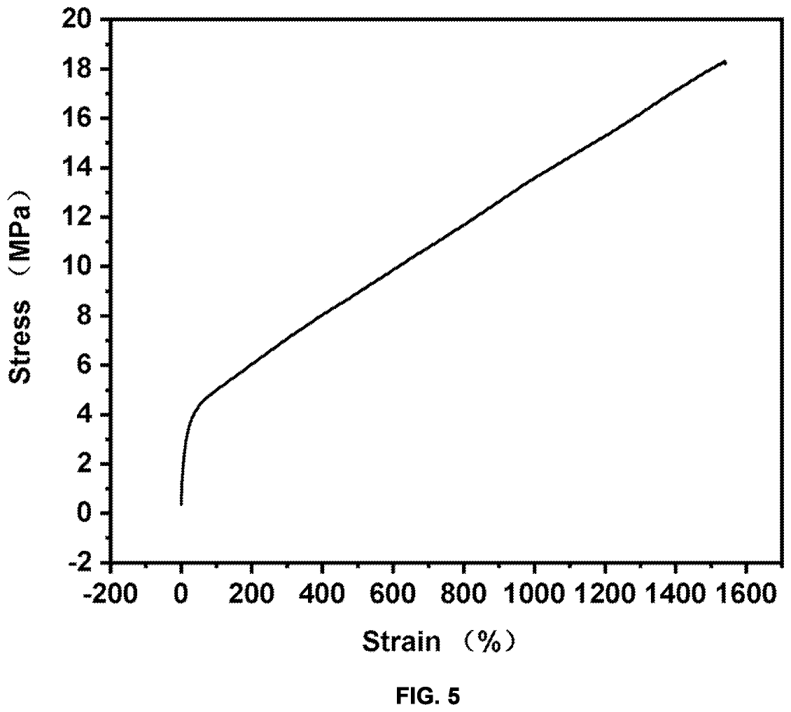

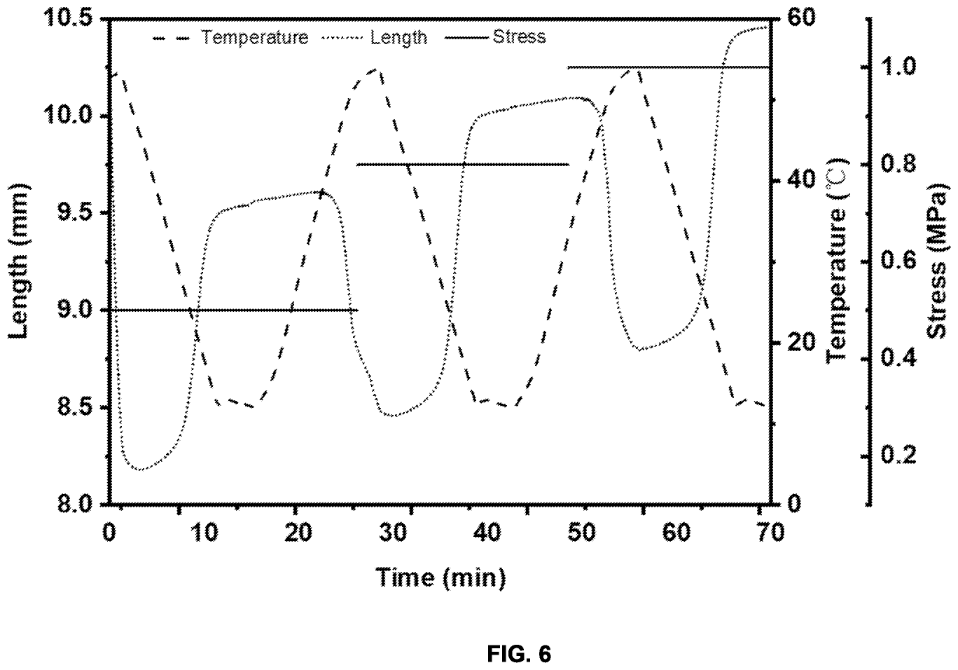

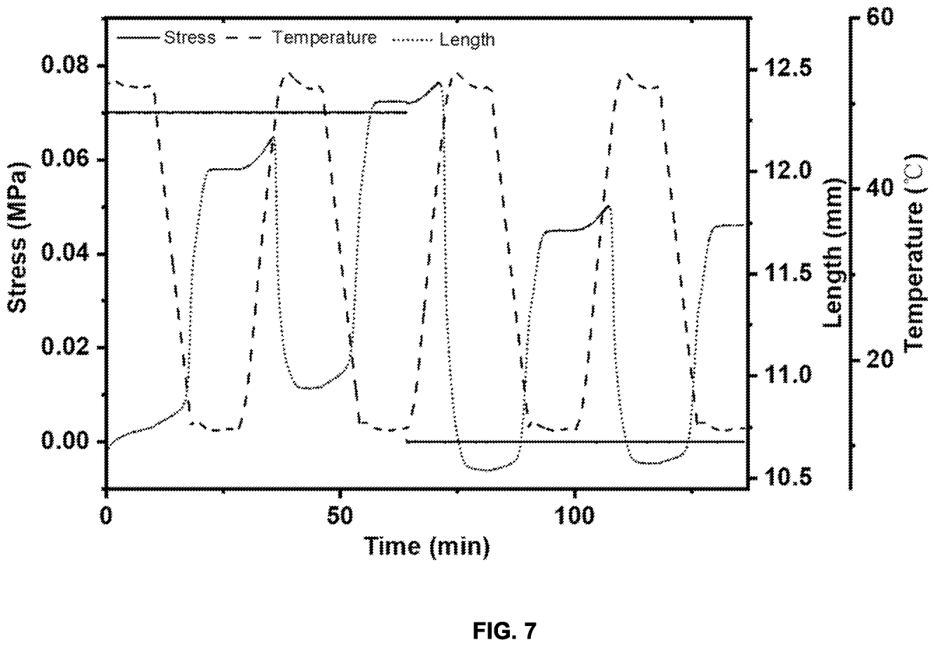

A resulting polyurethane film was demolded. Mechanical properties of the film were tested with a universal electronic tensile tester, and shape memory performance of the film was tested with a dynamic mechanical analyzer. The results of tests are shown in FIG. 5, FIG. 6, and FIG. 7, respectively.

FIG. 5 shows a tensile stress-strain curve of the polyurethane material in this example. As can be seen from FIG. 5, the material has a tensile strength of 18 MPa and an elongation at break of 1,539%.

FIG. 6 shows a two-way shape memory curve of the polyurethane material in this example under an external stress. As can be seen from FIG. 6, a two-way reversible strain is 16.95% at 0.5 MPa, 19.15% at 0.8 MPa, and 18.73% at 1 MPa.

FIG. 7 shows a two-way memory behavior curve of the polyurethane material in this example under stress-free condition. As can be seen from FIG. 7, the material exhibits a reversible strain of 13.7% without an external stress.

### Example 3

A two-way shape memory polyurethane was prepared according to the following procedures:

At room temperature, 0.3 g of hydroxyl-terminated polybutadiene with a weight-average molecular weight of 2,700, 0.7 g of hydroxyl-terminated polycaprolactone with a weight-average molecular weight of 6,000, and 0.2 g of isophorone diisocyanate were dissolved in 10 mL of DMF at 60° C. and mixed evenly by stirring. A resulting mixture was heated to 80° C., and 75 mg of dibutyltin dilaurate was added dropwise thereto as a catalyst. A reaction was conducted under nitrogen protection at a rotation speed of 600 r/min for 1 h, obtaining a first prepolymer.

0.4 g of polyethylene glycol with a weight-average molecular weight of 1,000 and 0.08 g of TEA were dissolved in 5 mL of DMF at 60° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles, and then evenly transferred to a square polytetrafluoroethylene mold. The mold was transferred to an oven at 80° C. and dried for 8 h to remove the solvent.

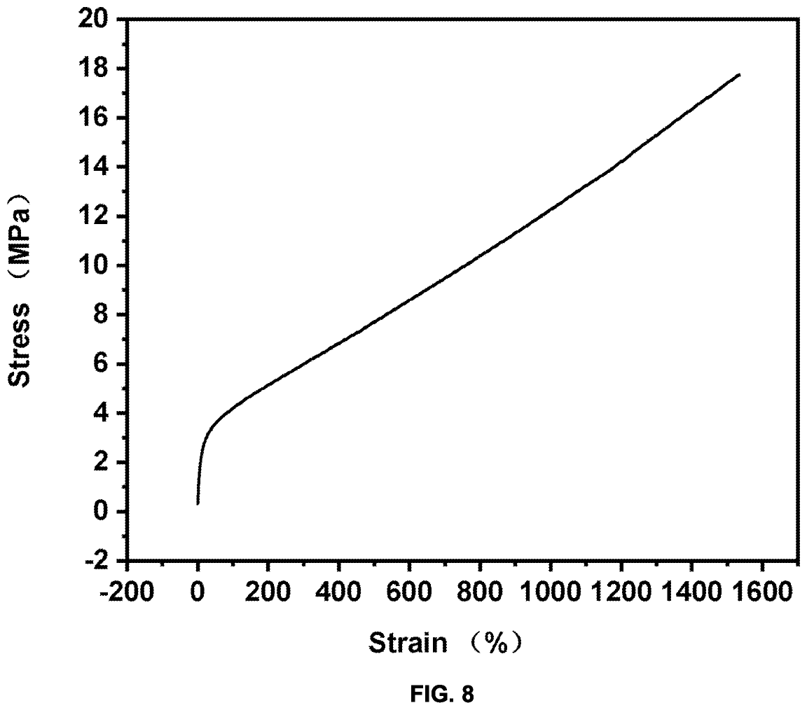

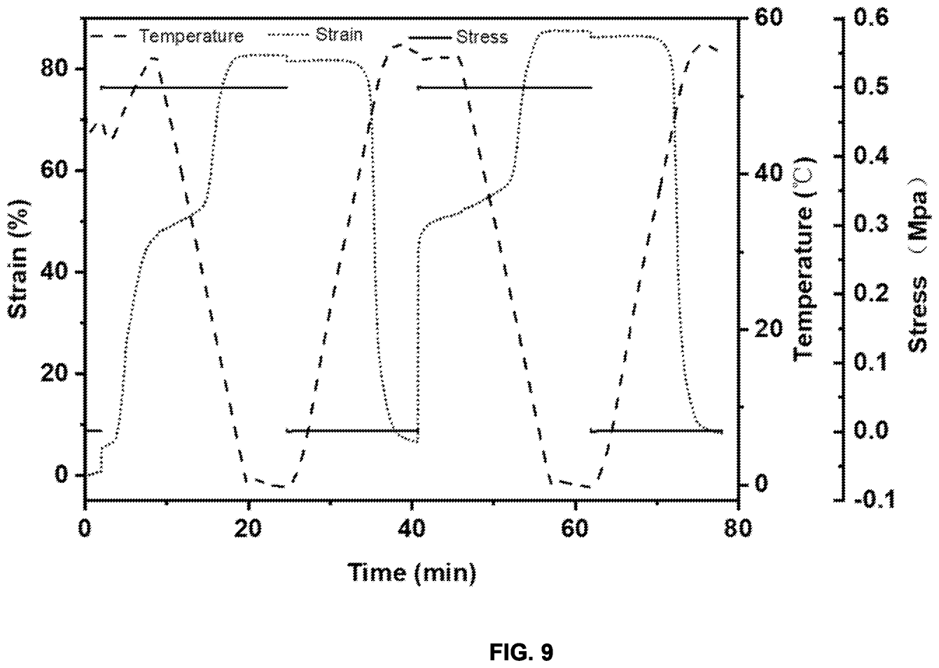

A resulting polyurethane film was demolded. The mechanical properties of the film were tested with a universal electronic tensile tester, and shape memory performance of the film was tested with a dynamic mechanical analyzer. The results of tests are shown in FIG. 8 and FIG. 9, respectively.

FIG. 8 shows a tensile stress-strain curve of the polyurethane material in this example. As can be seen from FIG. 8, the material has a tensile strength of 17.7 MPa and an elongation at break of 1,534%.

FIG. 9 shows the shape fixation and recovery of the polyurethane material in this example at different temperatures. As can be seen from FIG. 9, a strain recovery rate reaches 96.8%.

### Example 4

A two-way shape memory polyurethane was prepared according to the following procedures:

At room temperature, 0.5 g of hydroxyl-terminated polybutadiene with a weight-average molecular weight of 4,600, 0.7 g of hydroxyl-terminated polycaprolactone with a weight-average molecular weight of 6,000, and 0.2 g of hexamethylene diisocyanate were dissolved in 15 mL of DMF at 60° C. and mixed evenly by stirring. A resulting mixture was heated to 80° C., and 85 mg of dibutyltin dilaurate was added dropwise thereto as a catalyst. A reaction was conducted under nitrogen protection at a rotation speed of 600 r/min for 1 h, obtaining a first prepolymer.

0.3 g of polyethylene glycol with a weight-average molecular weight of 6,000 and 0.08 g of HPED were dissolved in 5 mL of DMF at 60° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles therein, and then evenly transferred to a square polytetrafluoroethylene mold. The mold was transferred to an oven at 80° C. and dried for 8 h to remove the solvent.

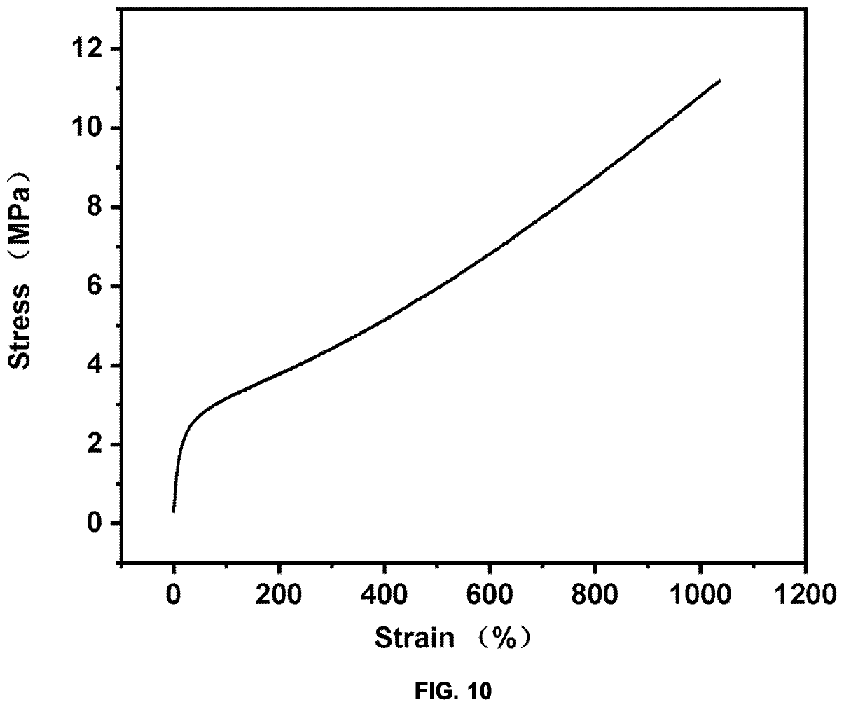

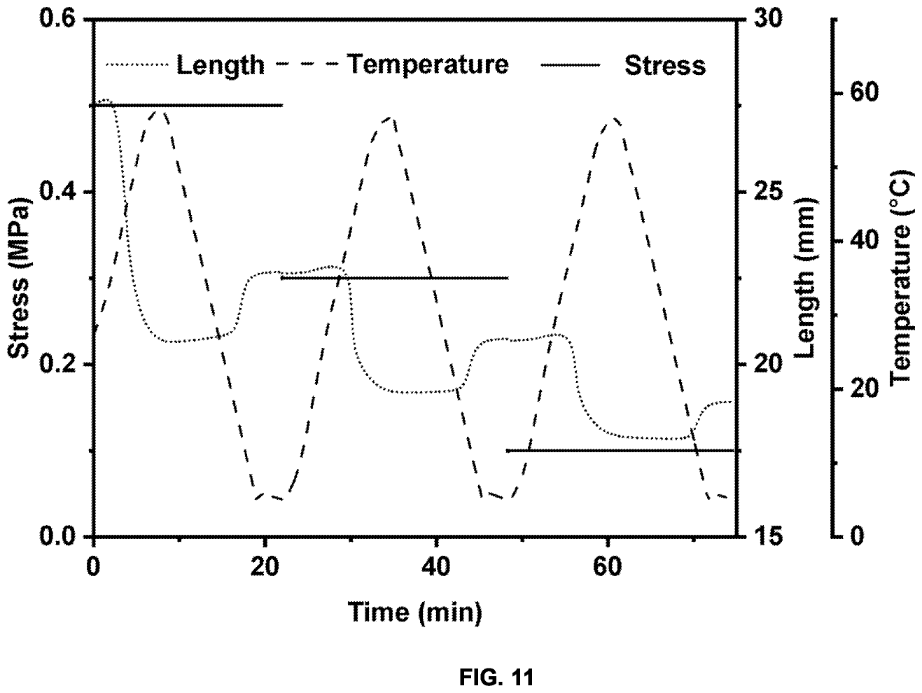

A resulting polyurethane film was demolded. The mechanical properties of the film were tested with a universal electronic tensile tester, and shape memory performance of the film was tested with a dynamic mechanical analyzer. The results of tests are shown in FIG. 10 and FIG. 11, respectively.

FIG. 10 shows a tensile stress-strain curve of the polyurethane material in this example. As can be seen from FIG. 11, the material has a tensile strength of 11.2 MPa and an elongation at break of 1,036%.

FIG. 11 shows a two-way shape memory curve of the polyurethane material in this example under external stress. As can be seen from FIG. 11, a two-way reversible strain is 10.44% at 0.5 MPa, 8.6% at 0.3 MPa, and 6.1% at 0.1 MPa.

### Example 5

A two-way shape memory polyurethane was prepared according to the following procedures:

At room temperature, 0.7 g of hydroxyl-terminated polybutadiene with a weight-average molecular weight of 2,700, 0.7 g of hydroxyl-terminated polycaprolactone with a weight-average molecular weight of 20,000, and 0.2 g of hexamethylene diisocyanate were dissolved in 10 mL of ethyl acetate at 65° C. and mixed evenly by stirring. A resulting mixture was heated to 80° C., and 100 mg of dibutyltin dilaurate was added dropwise thereto as a catalyst. A reaction was conducted under nitrogen protection at a rotation speed of 600 r/min for 1 h, obtaining a first prepolymer.

0.3 g of polyethylene glycol with a weight-average molecular weight of 6,000 and 0.08 g of HPED were dissolved in 3 mL of ethyl acetate at 60° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles, and then evenly transferred to a square polytetrafluoroethylene mold. The mold was transferred to an oven at 80° C. and dried for 8 h to remove the solvent.

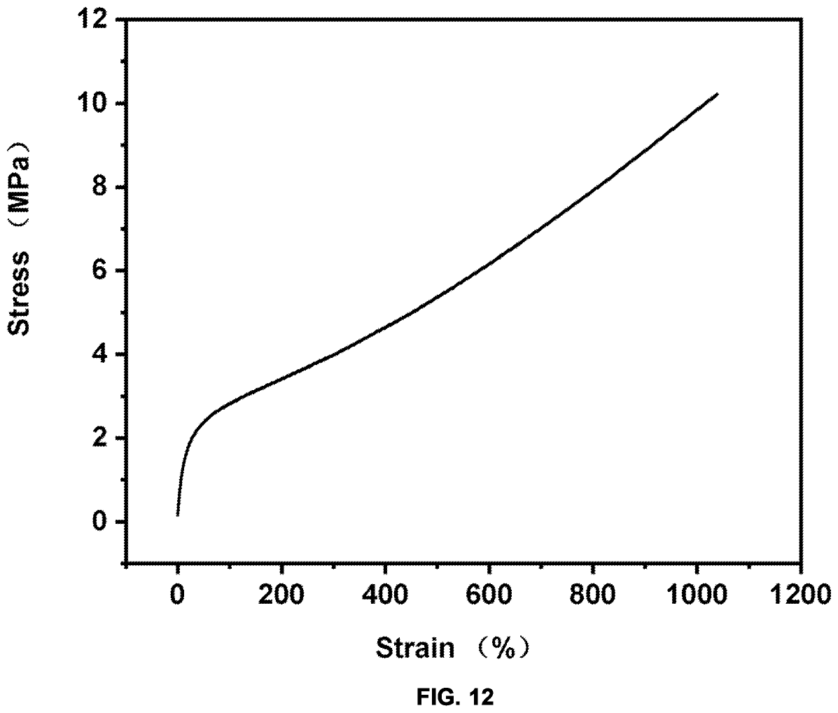

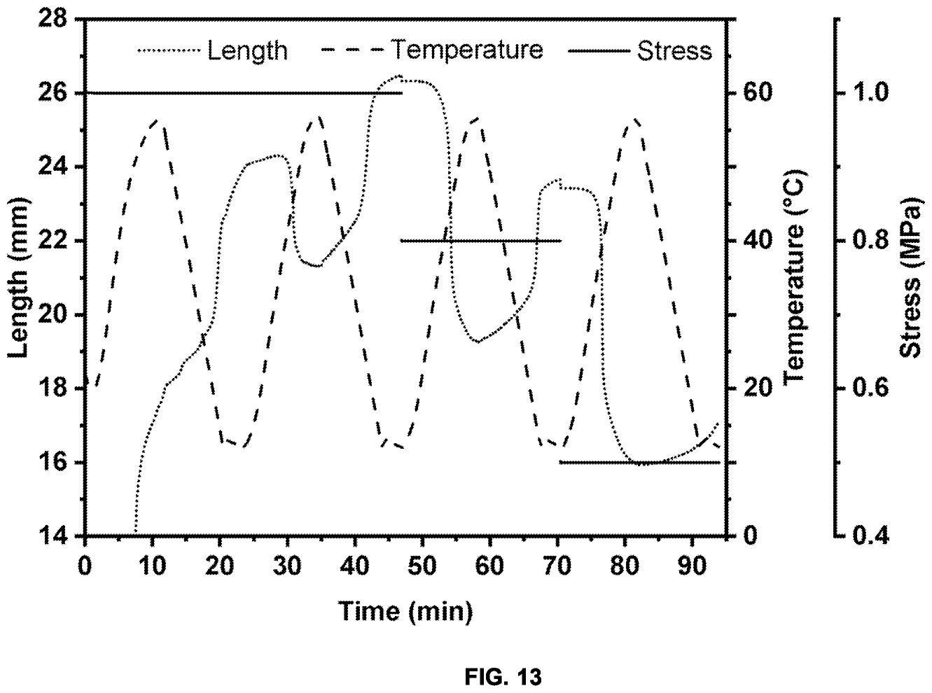

A resulting polyurethane film was demolded. The mechanical properties of the film were tested with a universal electronic tensile tester, and shape memory performance of the film was tested with a dynamic mechanical analyzer. The results of tests are shown in FIG. 12 and FIG. 13, respectively.

FIG. 12 shows a tensile stress-strain curve of the polyurethane material in this example. As can be seen from FIG. 12, the material has a tensile strength of 10.2 MPa and an elongation at break of 1,038%.

FIG. 13 shows a two-way shape memory curve of the polyurethane material in this example under external stress. As can be seen from FIG. 13, a two-way reversible strain is 7.46% at 0.5 MPa, 22.91% at 0.3 MPa, and 24.53% at 0.1 MPa.

### Example 6

A two-way shape memory polyurethane was obtained through step-by-step polymerization of hydroxyl-terminated polybutadiene, hydroxyl-terminated polycaprolactone, and polyethylene glycol. The specific procedures were as follows:

10 g of hydroxyl-terminated polybutadiene with a weight-average molecular weight of 3,200, 11.5 g of hexamethylene diisocyanate, and 70 g of hydroxyl-terminated polycaprolactone with a weight-average molecular weight of 30,000 were dissolved in a solvent DMF, and reacted at 90° C. under nitrogen protection for 1 h, obtaining a first prepolymer, wherein the solvent was added such that a final product had a mass of 91.5 g.

30 g of polyethylene glycol with a weight-average molecular weight of 6,000 and 8 g of HPED were added into the first prepolymer, and a reaction was conducted at 75° C. under nitrogen protection for 1 h, obtaining a second prepolymer.

The air bubbles were removed from the second prepolymer under vacuum. The second prepolymer was then transferred to a polytetrafluoroethylene mold, and polymerization was conducted at 100° ° C. while removing the solvent for 6 h, obtaining a polymer film with excellent mechanical properties.

The properties of the polymer film obtained in this example were tested in a same way as described in Example 1. The results are as follows:

The polymer film has a tensile strength of 19.5 MPa, an elongation at break of 1,927%, a strain fixity rate of 98.15%, and a strain recovery rate of 98.2%.

### Comparative Example 1

This comparative example was performed similarly as described in Example 1, expect that no cross-linking agent was added. A two-way shape memory polyurethane was prepared according to the following procedures:

At room temperature, 0.05 g of hydroxyl-terminated polybutadiene with a weight-average molecular weight of 2,700, 0.7 g of hydroxyl-terminated polycaprolactone with a weight-average molecular weight of 20,000, and 0.09 g of hexamethylene diisocyanate were dissolved in 10 mL of ethyl acetate at 65° C. and mixed evenly by stirring. A resulting mixture was heated to 80° C., and 50 mg of dibutyltin dilaurate was added dropwise thereto as a catalyst, and a reaction was conducted under nitrogen protection at 600 r/min for 1 h, obtaining a first prepolymer.

0.3 g of polyethylene glycol with a weight-average molecular weight of 6,000 was dissolved in 3 mL of ethyl acetate at 60° C. The resulting mixture was slowly added to the first prepolymer. The resulting system was adjusted to 70° C., and reaction was conducted under nitrogen protection for 1 h, obtaining a polyurethane prepolymer solution.

The polyurethane prepolymer solution was treated in a vacuum environment for 5 min to remove air bubbles therein, and then evenly transferred to a square polytetrafluoroethylene mold. The mold was transferred to an oven at 80° ° C. and dried for 8 h to remove the solvent.

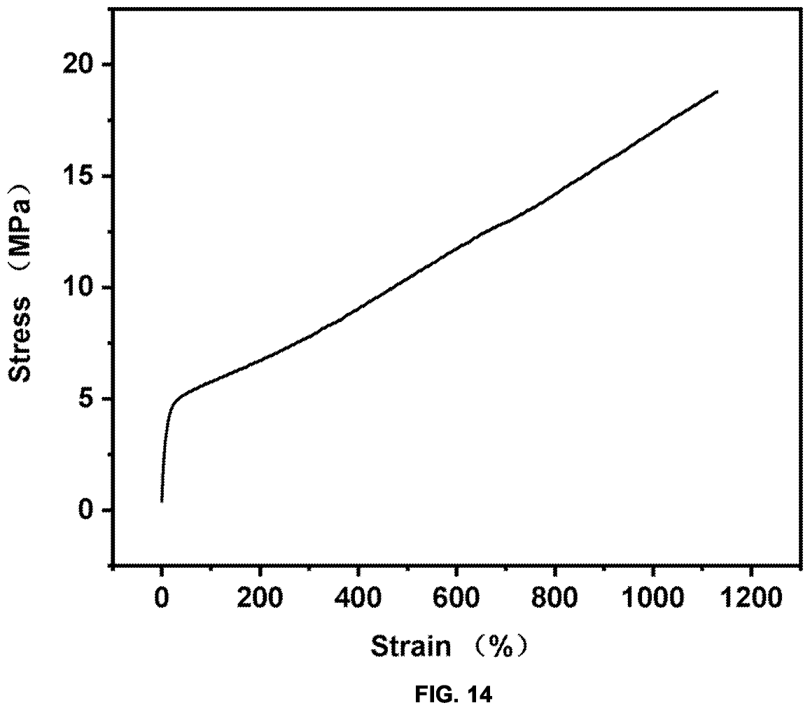

A resulting polyurethane film was demolded. The mechanical properties of the film were tested with a universal electronic tensile tester, and shape memory performance of the film was tested with a dynamic mechanical analyzer. The results of tests were shown in FIG. 14.

In this comparative example, the polyurethane material had a tensile strength of 18.8 MPa and an elongation at break of 1,130%. The tensile strength and elongation at break were significantly lower than those in Example 1.

In this comparative example, since no cross-linking agent was added, the product obtained had a linear network structure. After being fixated into a temporary shape, the polymer network structure changed. During heating, there was small deformation in the polyurethane due to the recovery of the stretched crystalline segments, but its original shape was not restored, not showing an obvious shape memory behavior.

### Comparative Example 2

A polymer film material with a high dielectric constant was prepared according to the following procedures:

At room temperature, 1 g of hydroxyl-terminated polybutadiene with a weight-average molecular weight of 2,700, 0.4 g of hydroxyl-terminated polycaprolactone with a weight-average molecular weight of 20,000, and 0.2 g of hexamethylene diisocyanate were dissolved in 5 mL of DMF at 60° C. and mixed evenly by stirring. A resulting mixture was heated to 80° C., and 80 mg of dibutyltin dilaurate was added dropwise thereto as a catalyst, and a reaction was conducted under nitrogen protection at a rotation speed of 600 r/min for 1 h, obtaining a first prepolymer.

0.4 g of polyethylene glycol with a weight-average molecular weight of 6,000 was dissolved in 1 mL of DMF at 60° C. The resulting mixture was slowly added to the first prepolymer. The resulting system was heated to 70° C., and reaction was conducted under nitrogen protection for 1 h, obtaining a second prepolymer.

0.03 g of 4-hydroxymethyl-4′-hydroxyazobenzene was added to the second prepolymer, and then reaction was conducted at 75° C. under nitrogen protection for 15 min, obtaining a polyurethane prepolymer solution.

The polyurethane prepolymer solution was treated in a vacuum environment for 5 min to remove air bubbles therein, and then evenly transferred to a square polytetrafluoroethylene mold. The mold was transferred to an oven at 80° C. and dried for 8 h to remove the solvent.

A resulting polyurethane film was demolded. The mechanical properties of the film were tested with a universal electronic tensile tester, and shape memory performance of the film was tested with a dynamic mechanical analyzer.

In this comparative example, the polyurethane material had a tensile strength of 38.5 MPa and an elongation at break of 192%. The tensile strength and elongation at break were significantly lower than those in Example 1.

In this comparative example, the product was also a linear network structure and did not show an obvious shape memory behavior. The shape memory performance statistics of the materials obtained in examples and comparative examples are shown in Table 1.

TABLE 1
Shape memory properties of polyurethane obtained
in examples and comparative examples

| | Strain | Strain | Energy | Power | Tensile | Elongation |
|---|---|---|---|---|---|---|
| | fixity | recovery | density, | density, | strength, | at |
| Samples | rate, R_{f} | rate, Rᵣ | J/kg | W/kg | MPa | break, % |
| Example 1 | 99.45 | 98.2 | 708.04 | 667.96 | 24 | 2343 |
| Example 2 | 93.90 | 97.5 | 358.01 | 319.65 | 18 | 1539 |
| Example 3 | 93.35 | 96.8 | 416.05 | 371.47 | 17.7 | 1534 |
| Example 4 | 67.7 | 95.9 | 231.53 | 159.67 | 11.2 | 1036 |
| Example 5 | 65 | 95.3 | 202.22 | 133.04 | 10.2 | 1038 |
| Example 6 | 98.15 | 98.2 | 356.9 | 305.47 | 19.5 | 1927 |
| Comparative | / | / | / | / | 18.8 | 1130 |
| Example 1 | | | | | | |
| Comparative | / | / | / | / | 38.5 | 192 |
| Example 2 | | | | | | |

The above examples are preferred embodiments of the present disclosure. However, the embodiments of the present disclosure are not limited by the above examples. Any changes made without departing from the spiritual essence and principle of the present disclosure should be an equivalent replacement, and should fall within the scope of the present disclosure.

The above examples are only used to illustrate the technical solutions of the present disclosure and are not intended to limit the present disclosure. Changes, substitutions, modifications, and simplifications made by those of ordinary skill in the art within the essential scope of the present disclosure are all equivalent transformations. These transformations do not depart from the spirit of the present disclosure and should also fall within the protection scope of the claims appended in the present disclosure.

What is claimed is:

1. A two-way shape memory polyurethane, comprising the following components: in parts by weight, 4 parts to 36 parts of hydroxyl-terminated polybutadiene, 35 parts to 85 parts of hydroxyl-terminated polycaprolactone, 7 parts to 21 parts of a diisocyanate, 15 parts to 45 parts of polyethylene glycol, and 4 parts to 10 parts of a cross-linking agent.

2. The two-way shape memory polyurethane as claimed in claim 1, wherein the hydroxyl-terminated polybutadiene has a weight-average molecular weight of 2,700 to 4,600, the hydroxyl-terminated polycaprolactone has a molecular weight of 3,000 to 50,000, and the polyethylene glycol has a weight-average molecular weight of 1,000 to 20,000.

3. The two-way shape memory polyurethane as claimed in claim 1, wherein the diisocyanate is at least one selected from the group consisting of isophorone diisocyanate, hexamethylene diisocyanate, and dicyclohexylmethane 4,4′-diisocyanate.

4. The two-way shape memory polyurethane as claimed in claim 1, wherein the cross-linking agent is at least one selected from the group consisting of N,N,N′,N′-tetrakis(2-hydroxypropyl)ethylenediamine and triethanolamine.

5. A method for preparing the two-way shape memory polyurethane as claimed in claim 1, comprising the steps of
(1) dissolving the hydroxyl-terminated polybutadiene, the diisocyanate, and the hydroxyl-terminated polycaprolactone in a solvent, adding dibutyltin dilaurate dropwise as a catalyst, and conducting reaction at a temperature of 70° C. to 90° C. under nitrogen protection for 1 h to 3 h to obtain a prepolymer;
(2) adding the polyethylene glycol and the cross-linking agent into the prepolymer, and conducting reaction at a temperature of 65° C. to 75° C. under nitrogen protection for 0.5 h to 1 h to obtain a polyurethane solution; and
(3) deaerating the polyurethane solution under vacuum to obtain a deaerated polyurethane solution, transferring the deaerated polyurethane solution to a mold, and conducting polymerization at a temperature of 80° C. to 120° C. while removing the solvent for 6 h to 8 h, to obtain the two-way shape memory polyurethane with a shape memory effect.

6. The method as claimed in claim 5, wherein the solvent is at least one selected from the group consisting of N,N-dimethylformamide, ethyl acetate, and cyclohexane.

7. The method as claimed in claim 5, wherein the two-way shape memory polyurethane has an elongation at break of 500% to 2,500% and a tensile strength of 5 MPa to 30 MPa.

8. The method as claimed in claim 5, wherein the two-way shape memory polyurethane has a strain fixity rate R_{f} of 60% to 99%, a strain recovery rate Rr of 95% to 99%, an energy density W of 200 J/kg to 710 J/kg, and a power density P of 130 W/kg to 670 W/kg.

9. The method as claimed in claim 5, wherein the two-way shape memory polyurethane with the shape memory effect exhibits a two-way shape memory behavior with a reversible strain of 5% to 25% under an external stress, and exhibits a two-way shape memory behavior with a reversible strain of 5% to 15% under stress-free condition.

10. The method as claimed in claim 5, further comprising in step (3), adjusting a shape and a size of the mold and an amount of the polyurethane solution to be cast to obtain polyurethane films with different forms.
